(19) United States
(12) Patent Application Publication
(10) Pub. No.: US 2009/0023505 A1
(43) Pub. Date: Jan. 22, 2009

(54) Adapter Ring for Transmission Pump Assembly to Engine Connection

(75) Inventors: Fredrick R. Poskie, Plymouth, MI (US); Scott H. Wittkopp, Ypsilanti, MI (US); Elizabeth I. Wooden, Farmington Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/780,653

(22) Filed: Jul. 20, 2007

(51) Int. Cl. F16D 1/02

(52) U.S. Cl. 464/147

(57) ABSTRACT

A transmission pump adapter ring is provided that enables a transmission pump assembly to be operatively connected to an engine, thus enabling a common transmission pump assembly to be used in a given type or types of transmissions while enabling different engines to be used with the transmission simply by changing the adapter ring. The adapter ring allows a novel method of assembling a powertrain that permits assembly of the transmission with a generic (i.e., common) type of pump assembly prior to a determination of the engine type or types to be used with the transmission.

### TECHNICAL FIELD

The invention relates to an apparatus for connecting a transmission pump assembly to an engine, as well as a method of assembling transmissions.

### BACKGROUND OF THE INVENTION

Vehicle powertrains are complex assemblies including a multitude of components. One of the main components of a powertrain is a transmission. Transmissions are often designed and built with the intention of being offered for use by various automotive manufacturers in different applications. Economies of scale and simplification of component handling during assembly dictate the use of at least some common transmission components in the different applications, and even in different types of transmissions (e.g., different transmission families having different torque and gear ratio specifications). Different engines are likely used in the different applications.

### SUMMARY OF THE INVENTION

A transmission pump adapter ring is provided that enables a transmission pump assembly to be operatively connected to an engine, thus enabling a common transmission pump assembly to be used in a given type or types of transmissions while enabling different engines to be used with the transmission simply by changing the adapter ring. The adapter ring has engine mounting features that are configured to mount to a predetermined engine mounting face on a specific type of engine and also has a pump-side mounting face adapted to mount to a pump assembly mounting face on the pump assembly. The adapter ring is separate from, and mountable to both the pump assembly and the engine. Thus, the adapter ring enables an engine to be connected with any transmission that utilizes the particular type of pump assembly. A generic pump assembly may be utilized. Because generic pump assemblies contain numerous ferrous components, preassembly is not desirable if the pump assemblies are engine-specific in design and must be stored until assembly of the transmission for use with that particular engine is required. Simply by using different adapter rings, a given type of transmission can be utilized with different engines. The adapter rings are relatively small and easy to store, and may be pre-produced and stored until needed. With the adapter ring, it is not necessary to produce a customized pump and bell housing assembly for each vehicle model as is currently done.

Accordingly, in one aspect of the invention, an annular adapter ring has a pump-side mounting face at one end adapted to mount to a transmission pump assembly with a pump assembly mounting face. The adapter ring also has an engine-side mounting face at an opposing end that is adapted to mount to a predetermined engine mounting face of a particular type of engine. Preferably the pump-side mounting face and the engine-side mounting face of the adapter ring are characterized by bolt patterns identical to bolt patterns of the pump assembly and of the engine, respectively.

In another aspect of the invention, because the adapter ring is a separate component from the transmission casing and from the engine, both may be manufactured separately from the adapter ring, and the adapter ring can be selected from a suitable material somewhat independently of the material used for the transmission and for the engine. For example, the adapter ring may be magnesium, rather than steel, in order to reduce weight and improve fuel economy.

Within the scope of the invention, a powertrain is provided that includes a transmission having a casing and a torque converter operatively connectable thereto. The powertrain includes a pump assembly having a transmission pump adapted to mount to and be powered by the torque converter, as well as a bell housing, also referred to as a pump cover, that is adapted to mount to the transmission casing. The pump assembly, with transmission pump and bell housing, may be preassembled prior to mounting to the transmission casing and the torque converter. The power train also includes an engine having an engine mounting face, such as with a specific engine bolt pattern. The powertrain includes an annular pump assembly adapter ring that has a pump-side mounting face adapted to mount to the bell housing and an engine-side mounting face adapted to mount to the engine mounting face, to thereby connect the pump assembly with the engine.

The adapter ring allows a novel method of assembling a powertrain that permits assembly of the transmission with a generic (i.e., common) type of pump assembly prior to a determination of the engine type or types to be used with the transmission. The method includes maintaining an inventory of transmissions of a first type, each connected with a respective transmission pump assembly of a first type with a transmission pump of a first type and a bell housing of a first type. The method includes mounting an adapter ring to the bell housing of the pump assembly of one of the transmissions. The adapter ring has an engine-side mounting face opposite the bell housing that is configured with a predetermined engine bolt pattern adapted for connection with a first type of engine that has the predetermined engine bolt pattern.

Because only the adapter ring has an engine specific feature (the engine mounting bolt pattern), the method may include mounting a second adapter ring of a second type to the bell housing of a second pump assembly on a second transmission selected from the inventory (i.e., the second transmission and its pump assembly being of identical types as those of the first transmission). The adapter ring of the second type has an engine-side mounting face opposite the bell housing that is configured with a second, different, predetermined engine bolt pattern so that the second adapter ring is configured for connection with a second type of engine having the second engine bolt pattern. Thus, the same generic type of pump assembly (i.e., that of the first type) may be used in different applications of a transmission type, i.e., when different types of engine are to be used with a given type of transmission, by utilizing different engine-specific adapter rings.

Within the scope of the invention, the entity (e.g., the vehicle manufacturer or assembler) that mounts the adapter rings may or may not also mount the pump assemblies and torque converters to the transmission. Those assembly operations could be carried out by different entities at different stages of the powertrain assembly. However, if the same entity maintaining the inventory of transmissions, such as, for example, the manufacturer of the transmissions, also assembles the pump assemblies and the torque converters in the transmission, then the method may include, prior to mounting the first adapter ring, mounting the first pump assembly to the first transmission, and prior to mounting the second adapter ring, mounting the second pump assembly to the second transmission.

Furthermore, the entity that maintains the inventory of transmissions may or may not manufacture the adapter rings, and, in either case, may maintain an inventory of the different types of adapter rings and select the appropriate type of adapter ring for mounting to the bell housing of the pump assemblies on the transmissions, as described above, based on orders received for use of the transmissions with the specified type or types of engines. This permits flexibility in manufacturing output. Also, because the adapter rings are the only engine-specific component, there is no need to separate components ion the pump assembly and the torque converter assembly areas of the assembly plant, as a common type of each is used with all of the transmissions of the first type regardless of the engine type to be used.

Within the scope of the invention, particularly if it is expected that a given type of transmission will be used with two or more different types of engines, the method may include maintaining an inventory of adapter rings of the first and second types, receiving an order for the first type of transmission to be used with the first type of transmission, and, in response to the order, selecting the first type of adapter ring from the inventory for the step of mounting the first adapter ring described above. This allows the transmission with the pump assembly to be preassembled, and only the adapter rings need be maintained in a separate, engine specific inventory. Similarly, the method may include receiving an order for the first type of transmission to be used with the second type of engine, and, in response to the order, selecting the second type of adapter ring from the inventory to be used for the step of mounting the second adapter ring described above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration in exploded view of a first powertrain having a transmission, torque converter, pump assembly and first type of engine with an adapter ring to connect the pump assembly with the engine;

FIG. 2 is a schematic side view illustration in exploded view of a second powertrain having a transmission, torque converter, and a pump assembly, each of the same type as the corresponding components of FIG. 1, and a second type of engine with another type of adapter ring to connect the pump assembly with the second type of engine;

FIG. 3 is a schematic perspective illustration of the adapter ring of FIG. 1;

FIG. 4 is a schematic perspective illustration of the adapter ring of FIG. 2; and

FIG. 5 is a flow chart illustrating a method of assembling a powertrain such as those of FIGS. 1 and 2.

### DESCRIPTION OF THE PREFERRED EMBODIMENTS

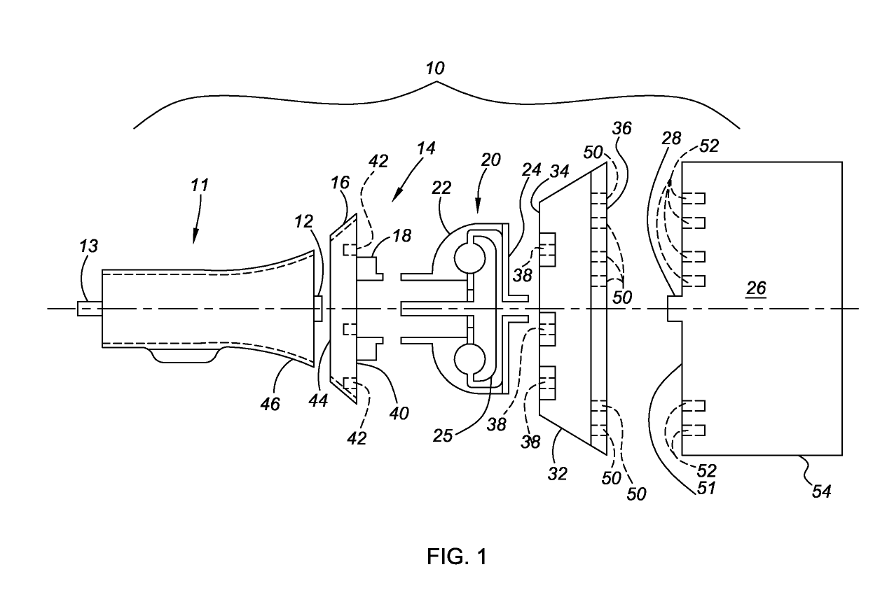

Referring to the drawings, wherein like reference numbers refer to like components, FIG. 1 shows a first powertrain 10 that includes a first transmission 11 of a first type, such as a specific six-speed automatic transmission with numerical speed and torque ratios between an input member 12 and an output member 13, determined by internal gear tooth ratios, as is known. Alternatively, the transmission 11 may be a hybrid or other type of transmission. The powertrain 10 also includes a pump assembly 14 that has a bell housing 16, also referred to as a pump cover, assembled integrally with a transmission pump 18, which includes typical pump components such as a rotor, vanes, springs, valves, and a pump body, as is known. The pump assembly 14 may be any commercially available pump assembly that has an integral pump bell housing 16. When fully assembled, the pump 18 provides hydraulic fluid to the transmission 11.

The powertrain 10 further includes a torque converter 20. The torque converter 20 is a conventional arrangement that has a pump portion 22 drivingly connected with the pump 18, as is known, and with a driving component 24 such as a flywheel or damper assembly. A turbine portion 25 of the torque converter 20 is fluidly driven by the pump portion 22 and operatively connects to the transmission input member 12.

The powertrain 10 also includes an engine 26, which may be an internal combustion engine, a fuel cell, or other type of power plant. The driving component 24 is driven by an output member 28 of the engine 26. The engine 26 is a first type of engine having certain characteristic design parameters, such as displacement volume, number and orientation of cylinders, etc., or other design parameters depending on the type of engine.

It is desirable to be able to utilize the transmission 11 with many different engine applications while maintaining as many generic or common components, such as the pump assembly 14, throughout the various applications. In order to make this possible, the powertrain 10 also includes an adapter ring 32 provided to connect the generic pump assembly 14 with the specific first type of engine 26. The adapter ring 32 is a first type of adapter ring, having a pump-side mounting face 34 at one end and an engine-side mounting face 36 at an opposing end. The adapter ring 32 may be magnesium or other suitable material. The pump-side mounting face 34 includes features adapting the adapter ring 32 for connection to the pump bell housing 16, such as mounting features 38, shown as bolt openings. The pump-side mounting face 34 and bolt openings 38 correspond to fit with a pump assembly mounting face 40 and mounting features 42, such as bolt openings, on the pump bell housing 16. The bolt openings 38 and 42 align and the pump-side mounting face 34 fits with the pump assembly mounting face 40. The adapter ring 32 is bolted and doweled (or piloted) to the pump assembly 14. The other end of the bell housing 16 has a transmission-side mounting face 44 that has features, such as bolt openings (not shown), that align with features in a transmission casing 46 enveloping the transmission 11 to allow connection of the bell housing 16 to the casing 46.

The engine-side mounting face 36 of the adapter ring 32 includes mounting features, such as bolt openings 50 arranged in a predetermined pattern to align with an engine mounting face 51 having an engine bolt pattern, represented by bolt openings 52 in the engine block 54 of the engine 26.

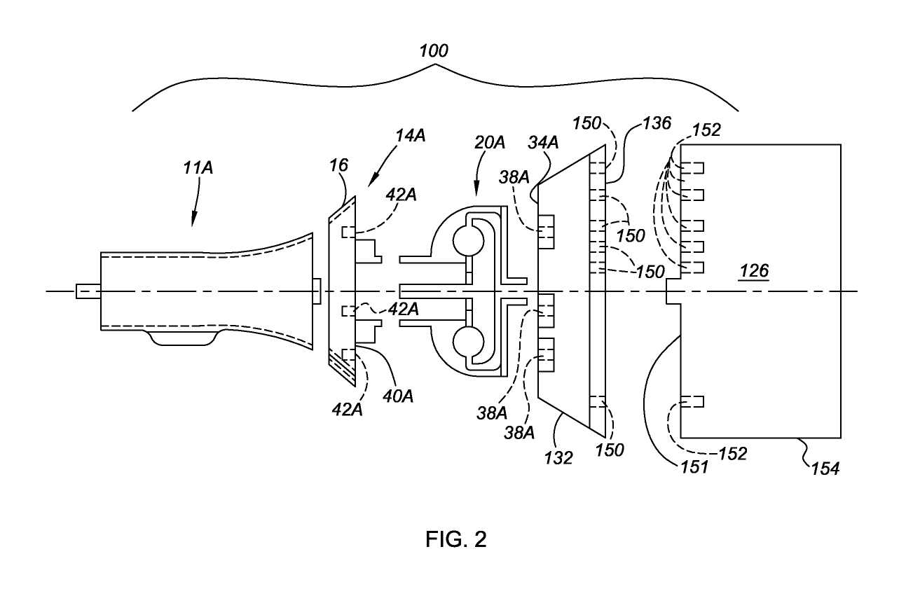

Because the adapter ring 32 is the only component of the powertrain 10 having engine-specific features, i.e., features that are adapted to specifically connect to a feature of the engine 26, such as the engine bolt pattern represented by openings 52, identical types of the remaining components of the powertrain 10 may be used without modification in powertrains having a different type of engine, and only a different type of adapter ring need be used. This is demonstrated by the powertrain 100 of FIG. 2 in which a second transmission of the same type as and identical to the transmission 11 of FIG. 1, is implemented, and is referred to with reference numeral 11A. The powertrain 100 also includes a pump assembly 14A identical in configuration and function to the pump assembly 14 of FIG. 1, and a torque converter 20A identical in configuration and function to the torque converter 20 of FIG. 1. The powertrain 100 includes an engine 126 that is of a second type, not identical in configuration to the engine 26 of FIG. 1, and specifically having an engine mounting face 151 with a second engine bolt pattern in engine casing 154 as represented by bolt openings 152 which differ in number and/or spacing from the openings 52 of the engine 26 of FIG. 1. Because a second adapter ring 132 of a second type is used that is different than the adapter ring 32 of the first type of FIG. 1, and that specifically has an engine-side mounting face 136 with mounting features, such as bolt openings 150 arranged in a predetermined pattern to align with the engine mounting face 151 having the second engine bolt pattern, represented by bolt openings 152. The pump-side mounting face of the second adapter ring 132 is the same as the pump-side mounting face 34 of the first adapter ring 32, and is referred to as 34A, as it has identically-spaced pump assembly mounting features represented by bolt openings, referred to as 38A, identical to bolt openings 38 of FIG. 1 so that the second adapter ring 132 can be mounted to the pump assembly mounting face 40A and to pump assembly bolt holes 42A of the pump assembly 14A of the first type, identical to the engine-side mounting face 40 and bolt openings 42 of the pump assembly 14 of FIG. 1.

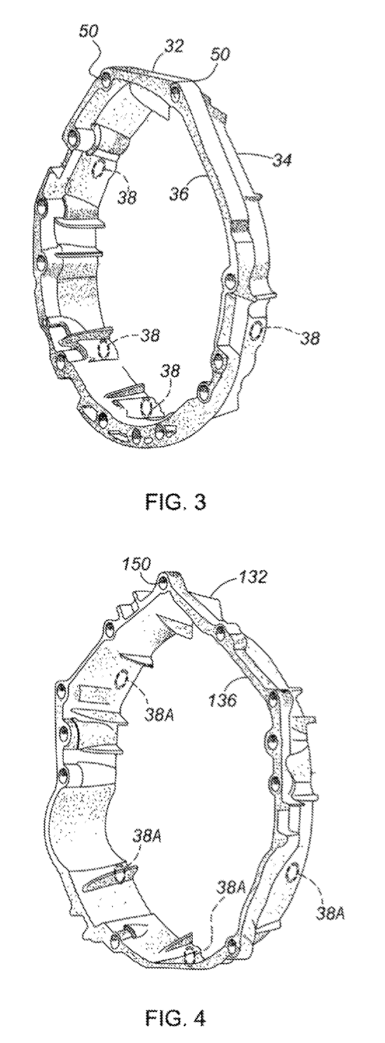

Referring to FIG. 3, the adapter ring 32 of FIG. 1 is shown in greater detail having the engine-side mounting face 36 with openings 50 spaced from one another to establish the first engine bolt pattern corresponding with the engine bolt pattern of engine 26 of FIG. 1 as represented by openings 52. The pump-side mounting face 34 is at the other end of the adapter ring 32 with openings 38 for connection to the pump assembly 14 of FIG. 1.

Referring to FIG. 4, the adapter ring 132 of FIG. 2 is shown in greater detail, having the engine-side mounting face 136 with openings 150 spaced from one another to establish the second engine bolt pattern corresponding with the engine bolt pattern of engine 126 of FIG. 2 as represented by openings 152. The pump-side mounting face 34A is at the other end of the adapter ring 132 with openings 38A for connection to the pump assembly 14A of FIG. 2.

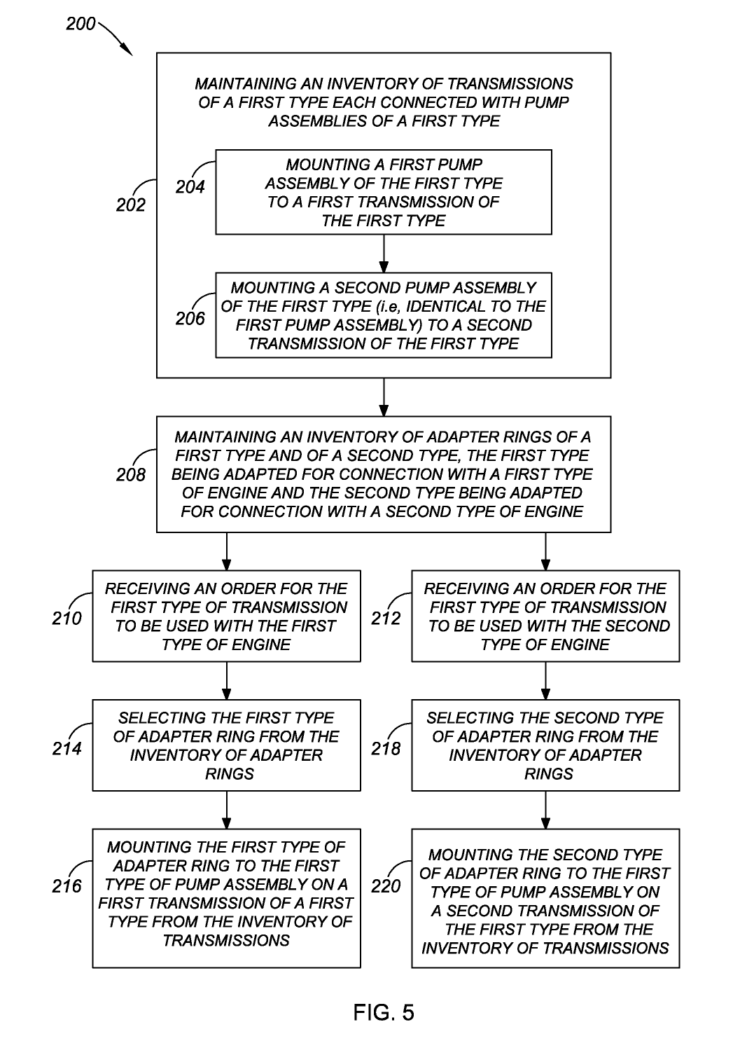

Referring to FIG. 5, a method of assembling powertrains 200 is illustrated in a flow diagram. The steps of the method 200 will be described with reference to the powertrains 10, 100 of FIGS. 1 and 2 and the adapter rings 32, 132 of FIGS. 1-4. The method 200 shown in FIG. 5 is a preferred embodiment, shows optional steps, and is not intended to be limited to the order of steps shown.

The method 200 includes step 202, maintaining an inventory of transmissions of a first type, such as transmissions 11 and 11A of FIGS. 1 and 2, each connected with a pump assembly of a first type, such as pump assemblies 14 and 14A, respectively. If the same entity maintaining the inventory of transmissions 11 and 11A also assembles the transmissions 11 and 11A with the pump assemblies 14 and 14A, then step 202 includes sub-step 204, mounting a first pump assembly of the first type (pump assembly 14 of FIG. 1) to a first transmission of the first type (transmission 11 of FIG. 1), and sub-step 206, mounting a second pump assembly of the first type (pump assembly 14A of FIG. 2) to a second transmission of the first type (transmission 11A of FIG. 2).

The method may also include step 208, maintaining an inventory of adapter rings of a first type (adapter ring 32 of FIG. 1) and of a second type (adapter ring 132 of FIG. 2), with the first type being adapted for connection to a first type of engine (engine 26 of FIG. 1) and the second type being adapted for connection to a second type of engine (engine 126 of FIG. 2).

Under the method, the entity assembling the transmissions may receive an order under step 210 for the first type of transmission to be used with the first type of engine. Additionally or alternatively, the entity may receive an order under step 212 for the first type of transmission to be used with the second type of engine. In response to step 210, the method 200 includes step 214, selecting the first type of adapter ring 32 from the inventory of adapter rings. After step 214, the method 200 includes step 216, mounting the first type of adapter ring 32 to the first type of pump assembly 14 of a first transmission 11 of the first type from the inventory of transmissions. Similarly, in response to step 212, the method 200 includes step 218, selecting the second type of adapter ring 132 from the inventory of adapter rings. After step 218, the method includes step 220, mounting the second type of adapter ring 132 to the first type of pump assembly 14A on a second transmission 11A of the first type from the inventory of transmissions.

While the best modes for carrying out the invention have been described in detail, those familiar with the art to which this invention relates will recognize various alternative designs and embodiments for practicing the invention within the scope of the appended claims.

1. An apparatus for connecting a transmission pump assembly having a pump assembly mounting face with an engine having a predetermined engine mounting face, the apparatus comprising:
an annular adapter ring having a pump-side mounting face at one end adapted to mount to the pump assembly mounting face and an engine-side mounting face at an opposed end adapted to mount to the predetermined engine mounting face.

2. The apparatus of claim 1, wherein the annular adapter ring is magnesium.

3. The apparatus of claim 1, wherein the pump assembly mounting face includes a predetermined pump assembly mounting bolt pattern; wherein the predetermined engine mounting face includes a predetermined engine mounting bolt pattern; wherein the adapter ring pump-side mounting face is characterized by the pump assembly mounting bolt pattern; and wherein the adapter ring engine-side mounting face is characterized by the engine mounting bolt pattern.

4. A powertrain comprising:
a transmission having a casing;
a torque converter operatively connectable to the transmission;
a pump assembly including a transmission pump and a bell housing; wherein the bell housing is adapted to mount to the transmission casing and the pump is adapted to operatively connect to the torque converter;
an engine having an engine mounting face; and
an annular pump assembly adapter ring having a pump-side mounting face adapted to mount to the bell housing and an engine-side mounting face adapted to mount to the engine mounting face, thereby connecting the pump assembly with the engine.

5. The powertrain of claim 4, wherein the pump assembly mounting face includes a predetermined pump assembly bolt pattern; wherein the predetermined engine mounting face includes a predetermined engine bolt pattern; wherein the adapter ring pump-side mounting face is characterized by the pump assembly bolt pattern; and wherein the adapter ring engine-side mounting face is characterized by the engine bolt pattern.

6. The apparatus of claim 5, wherein the annular adapter ring is magnesium.

7. A method of assembling a powertrain comprising:
maintaining an inventory of transmissions of a first type each connected with a respective transmission pump assembly of a first type; and
mounting an adapter ring to the pump assembly of a first of the transmissions in the inventory; wherein the adapter ring is configured with a predetermined engine mounting bolt pattern adapted for connection with a first type of engine.

8. The method of assembling of claim 7, wherein the adapter ring is a first adapter ring of a first type and the predetermined engine bolt pattern is a first engine bolt pattern on the first type of engine; and further comprising:
mounting a second adapter ring of a second type to the pump assembly of a second transmission of the first type from the inventory; wherein the second adapter ring is configured with a second predetermined engine bolt pattern adapted for connection with a second type of engine.

9. The method of claim 8, wherein the pump assembly of the first transmission is a first pump assembly and the pump assembly of the second transmission is a second pump assembly, and further comprising:
prior to said mounting the first adapter ring, mounting the first pump assembly to the first transmission; and
prior to said mounting the second adapter ring, mounting the second pump assembly to the second transmission.

10. The method of claim 8, further comprising:
prior to said mounting the first adapter ring, receiving an order for the first type of transmission to be used with the first type of engine;
maintaining an inventory of adapter rings of the first and second types; and
in response to said receiving the order for the first type of transmission to be used with the first type of engine, selecting the first adapter ring from the inventory for said mounting the first adapter ring.

11. The method of claim 8, further comprising:
prior to said mounting the second adapter ring, receiving an order for the first type of transmission to be used with the second type of engine;
maintaining an inventory of adapter rings of the first and second types; and
in response to said receiving the order for the first type of transmission to be used with the second type of engine, selecting the second adapter ring from the inventory for said mounting the second adapter ring.
